(19) United States
(12) Patent Application Publication
(10) Pub. No.: US 2007/0071452 A1
(43) Pub. Date: Mar. 29, 2007

(54) Optical-fiber wavelength generator, array structure and laser semiconductor device

(76) Inventor: Chien-Hung Yeh, Jhudong Township (TW)

Correspondence Address: J.C. Patents, Inc., Suite 250, 4 Venture, Irvine, CA, 92618, US

(21) Appl. No.: 11/271,539

(22) Filed: Nov. 9, 2005

(30) Foreign Application Priority Data
Sep. 27, 2005 (TW) 94133516

(51) Int. Cl. H04B 10/04

(52) U.S. Cl. 398/182

(57) ABSTRACT

An optical-fiber signal generator is provided, which includes a driving unit having an adjustable output current; a laser source driven by the output current, wherein a spectrum of the laser source includes at least one resonant wavelength; an optical coupler having a plurality of coupling terminals, wherein one of the coupling terminals is coupled to the laser source and another one of the coupling terminals serves as an output terminal for outputting an optical signal; an optical-fiber coupled to the coupler; at least one optical-fiber grating disposed on the optical-fiber, wherein each optical-fiber grating has a central wavelength. By adjusting the output current of the driving unit, one of the resonant wavelengths of the laser source is matched to the central wavelength of one of the fiber gratings to produce the optical signal.

### CROSS-REFERENCE TO RELATED APPLICATION

This application claims the priority benefit of Taiwan application serial no. 94133516, filed on Sep. 27, 2005. All disclosure of the Taiwan application is incorporated herein by reference.

### BACKGROUND OF THE INVENTION

1. Field of Invention

The present invention relates to an optical-fiber light source technology. More particularly, the present invention relates to an optical-fiber signal generating technology, wherein the optical-fiber signal has adjustable wavelength.

2. Description of Related Art

The technology of transmitting optical signals through optical-fiber has been widely used in communication to transmit information. And, network structure can also be implemented with optical-fiber. Therefore, the technology of transmitting information through optical-fiber is also one of the main technologies in communication technology.

However, one of the characteristics of optical-fiber is that optical signals of different wavelengths can be transmitted through the same optical-fiber. Thus, optical signals of different wavelengths are usually used for transmitting different information on a single optical-fiber route. In addition, optical signals are usually generated by laser units. Therefore, the laser unit is designed as to generate a plurality of light sources of different wavelengths in an adjustable manner.

Presently, the wavelength adjusting and wavelength switching technologies are generally achieved by using array distributed feedback (DFB) laser diode integrated with micromechatronics as the laser module of adjustable wavelength. Or, the laser unit of adjustable wavelength is designed by using other type of diode, e.g. distributed Bragg reflector (DBR) laser diode or rear sampled grating reflector (GCSR) laser diode etc, according to the different mechanism thereof. However, the manufacturing cost thereof is high and the process thereof is complex. Therefore, the manufacturers are still searching for other designs to lower the cost and simplify the entire structure for the convenience of manufacture.

### SUMMARY OF THE INVENTION

Accordingly, the present invention is directed to provide an optical-fiber signal generator, which can output signals having adjustable wavelengths and can reduce the manufacturing cost.

The present invention provides an optical-fiber signal generator, which includes a driving unit having an adjustable output current; a laser source driven by the output current of the driving unit, wherein a spectrum of the laser source includes at least one resonant wavelength; an optical coupler having a plurality of coupling terminals, wherein one of the coupling terminals is coupled to the laser source, and anther one of the coupling terminals serves as an output terminal for outputting an optical signal; an optical-fiber coupled to the coupler; at least one optical-fiber grating disposed on the optical-fiber, wherein each optical-fiber grating has a central wavelength. By adjusting the output current of the driving unit, one of the resonant wavelengths of the laser source is matched to the central wavelength of one of the fiber gratings to produce the optical signal.

According to an embodiment of the present invention, in the foregoing optical-fiber signal generator, the at least one optical-fiber grating is a plurality of optical-fiber gratings, and the at least one resonant wavelength of the laser source is a plurality of resonant wavelengths.

According to an embodiment of the present invention, in the foregoing optical-fiber signal generator, the driving unit includes a current source and a signal adjusting unit coupled to the current source, wherein the output current is altered by the signal adjusting unit to drive the laser source.

According to an embodiment of the present invention, in the forgoing optical-fiber signal generator, the laser source includes Fabry-Perot laser diode.

The present invention further provides an array structure for generating optical-fiber signals, which includes a plurality of wavelength signal generating units, wherein each of the wavelength signal generating units includes: a driving unit having an adjustable output current; a laser source driven by the output current of the driving unit, wherein a spectrum of the laser source includes at least a resonant wavelength; an optical coupler having a plurality of coupling terminals, one of the coupling terminals being coupled to the laser source, and another one of the coupling terminals serving as an output terminal for outputting an optical signal; an optical-fiber coupled to the coupler; at least one optical-fiber grating disposed on the optical-fiber, wherein each optical-fiber grating has a central wavelength.

Moreover, by adjusting the output current of the driving unit, one of the resonant wavelengths of the laser source is matched to the central wavelength of one of the fiber gratings to produce the optical signal.

According to an embodiment of the present invention, in the foregoing array structure for generating optical-fiber signals, after a desired wavelength has been obtained through adjusting of the laser source of each wavelength signal generating unit, the wavelength signal generating units generate the optical signals at the same time to form and output an optical array signal.

According to an embodiment of the present invention, in the foregoing array structure for generating optical-fiber signals, the laser sources of the wavelength generating units have the same spectrum characteristic.

According to an embodiment of the present invention, in the foregoing array structure for generating optical-fiber signals, the laser sources of the wavelength signal generating units include at least two different spectrum characteristics.

According to an embodiment of the present invention, in the foregoing array structure for generating optical-fiber signals, the central wavelengths of the optical-fiber gratings in the wavelength signal generating units are the same, or at least two of them are different.

According to an embodiment of the present invention, in the foregoing array structure for generating optical-fiber signals, an optical signal with desired wavelength is generated by switching one of the wavelength signal generating units.

According to an embodiment of the present invention, in the foregoing array structure for generating optical-fiber signals, the laser sources of the wavelength signal generating units include at least two different spectrum characteristics.

According to an embodiment of the present invention, in the foregoing array structure for generating optical-fiber signals, the central wavelengths of the optical-fiber gratings in the wavelength signal generating units are the same, or at least two of them are different.

According to an embodiment of the present invention, in the foregoing array structure for generating optical-fiber signals, in each of the wavelength signal generating units, the at least one optical-fiber grating is a plurality of optical-fiber gratings, and the at least one resonant wavelength of the laser source is a plurality of resonant wavelengths.

The present invention further provides a laser semiconductor device, which includes a driving circuit to generate an adjustable output current; a laser source structure driven by the output current of the driving circuit, wherein a spectrum of the laser source includes at least a resonant wavelength; a terminal structure used for coupling the components and outputting signals; an optical-fiber grating structure coupled to the laser optical structure through the terminal structure, wherein the optical-fiber grating structure includes at least an optical-fiber grating, and each optical-fiber gating has a central wavelength. By adjusting the output current of the driving unit, one of the resonant wavelengths of the laser source is matched to the central wavelength of one of the fiber gratings to produce an optical signal, which is output by the terminal structure.

In the present invention, the laser source, which can produce at least one resonant wavelength, and at least one optical-fiber grating are used to generate the desired optical signal by switching the resonant wavelength of the laser source to match it with the central wavelength of the optical-fiber grating. This structure is easy to be implemented and can reduce the manufacturing cost efficiently.

In order to make the aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic block diagram of an optical-fiber signal generator according to an embodiment of the present invention.

FIGS. 2A, 2B, 3A, and 3B illustrate the variation of spectrum of the laser source under different driving currents.

FIG. 4 illustrates the spectrums outputted in the embodiment in FIG. 1, according to the present invention.

FIG. 5 illustrates the switching response performance of an output signal according to an embodiment of the present invention.

FIG. 6 illustrates the structure of a wavelength output array according to an embodiment of the present invention.

FIGS. 7 and 8 illustrate a semiconductor laser device fabricated with the semiconductor fabricating technology according to an embodiment of the present invention.

### DESCRIPTION OF EMBODIMENTS

In the present invention, an optical-fiber signal generator device, which can output optical signals having adjustable wavelengths and has fast switching function, is designed using simple laser diode, e.g. Fabry-Perot diode, and optical-fiber grating with optical self-seeding mechanism. The present invention can accomplish this effect through, for example, adjusting the operation current of the Fabry-Perot laser diode. As verified by actual experiment, the laser structure provided by the present invention is very simple to implement and has at least characteristics as low cost, data direct modulation, and fast wavelength switching etc. The present invention will be explained with reference to some embodiments below, but the present invention is not limited to these embodiments.

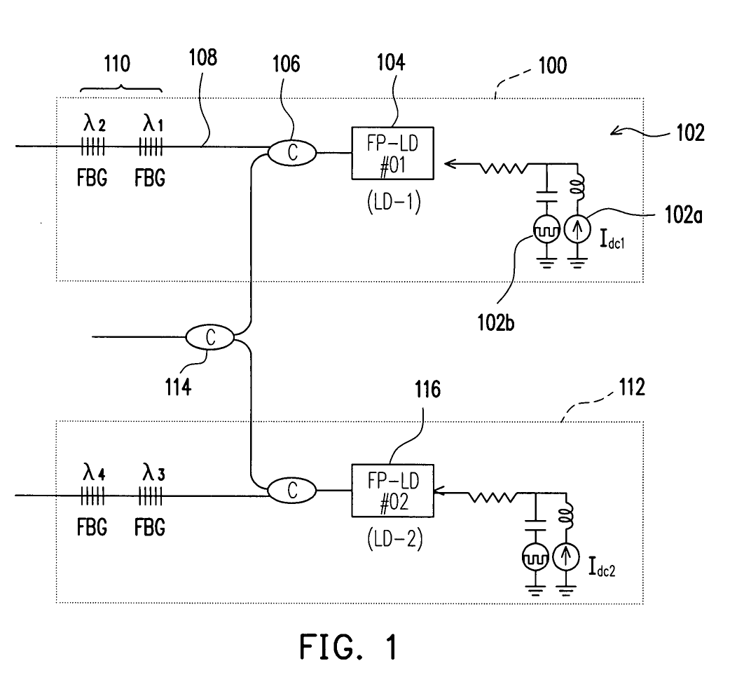

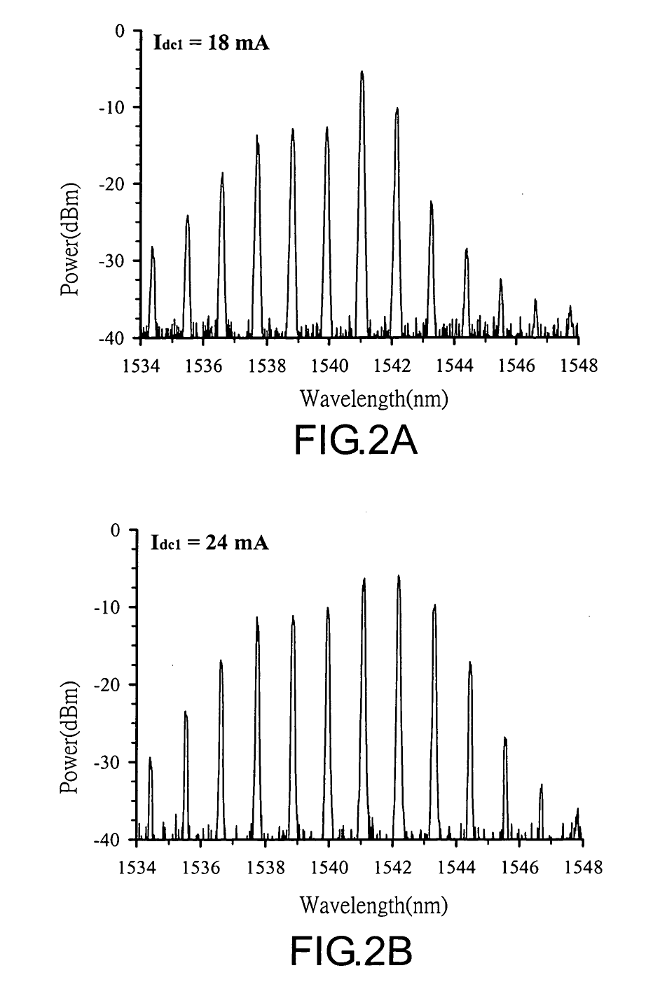

FIG. 1 is a schematic block diagram of an optical-fiber signal generator according to an embodiment of the present invention. In FIG. 1, the structure is, for example, an optical-fiber signal generator composed of two optical-fiber signal generating units 100 and 112. First, the optical-fiber signal generating unit 100 is explained as an example, which may serve as an optical-fiber signal generator by itself. The optical-fiber signal generating unit 100 includes a driving unit 102 having an adjustable output current. A laser source 104 is driven by the output current of the driving unit 102. A spectrum of the laser source 104 includes at least a resonant wavelength (refer to FIGS. 2A and 2B). An optical coupler 106 has a plurality of coupling terminals, wherein one of the coupling terminals is coupled to the laser source 104 and another one of the coupling terminals serves as an output terminal for outputting an optical signal. An optical-fiber 108 is coupled to the coupler 106. At least one optical-fiber grating 110 is disposed on the optical-fiber, wherein each optical-fiber grating has a central wavelength. Two optical-fiber gratings 110 are illustrated in FIG. 1 as an example. Moreover, the optical-fiber gratings 110 are, for example, Fiber Bragg Grating (FBG), which have predetermined central wavelengths λ₁ and λ₂, respectively. The number of the optical-fiber gratings 110 is determined according to the spectrum characteristics of the laser source 104, may be one or multiple. By adjusting the output current of the driving unit, one of the resonant wavelengths of the laser source is matched to the central wavelength of one of the fiber gratings to produce the optical signal.

The driving unit 102 described above has at least one spectrum, or multiple spectrums in preferable option, of resonant wavelength. Using the laser source 104 formed of a Fabry-Perot laser diode as the example, the corresponding driving unit 102 may include, for example, a current source 102a, and a signal adjusting unit 102b coupled to the current source, wherein the output current is altered by the signal adjusting unit to drive the laser source. The circuit structure of the driving unit 102 is understandable for those ordinarily skilled in the art, so will not be further described.

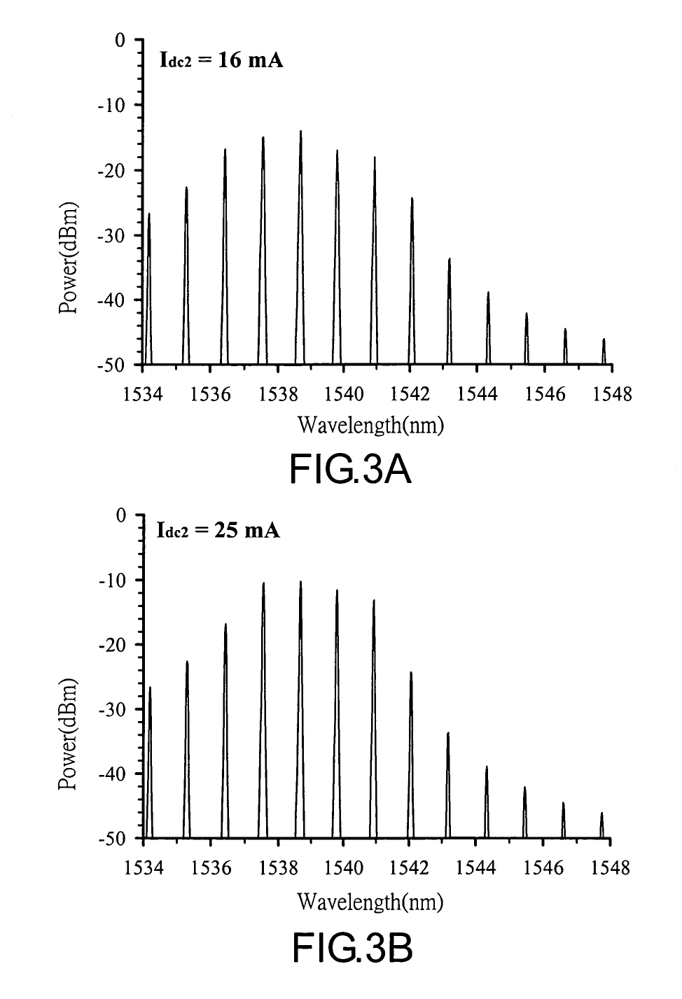

It is remarkable that the resonant wavelength of the spectrum outputted by the laser source 104 shifts along with the quantity of the driving current. FIG. 2A illustrates the spectrum outputted by the laser diode when the driving current Idc1=18 mA. But, when Idc1=24 mA, as shown in FIG. 2B, the spectrum outputted by the laser diode will shift, so that the position of the resonant wavelength will be moved too, thus different wavelengths can be obtained. In addition, FIGS. 3A and 3B illustrate the spectrums of the laser source 116 in the other optical-fiber signal generating unit 112 when Idc2=16 mA and Idc2=25 mA. In other words, when the design includes a plurality of generating units, e.g. optical-fiber signal generating units 102 and 112, the laser sources of the optical-fiber signal generating units 102 and 112 may be two laser sources 104 and 116 of different spectrum characteristics. And, the two laser sources 104 and 116 may also have the same spectrum characteristics. The final output thereof has to be disposed correspondingly based on the central wavelength of the optical-fiber gratings 110, the mechanism thereof will be described below.

In the present invention, one or a plurality of optical-fiber gratings 110 are disposed on the optical-fiber 108. For example, in the present embodiment, two optical-fiber gratings 110 having central wavelengths λ₁ and λ₂ (e.g. 1539.78 nm and 1540.92 nm) respectively are implemented in the optical-fiber signal generating unit 100. Similarly, two optical-fiber gratings 110 having central wavelengths λ₃ and λ₄ (e.g. 1542.04 nm and 1543.16 nm) respectively are implemented in the optical-fiber signal generating unit 112. Wavelengths λ₁, λ₂, λ₃, and λ₄ are the desired switchable central wavelengths. The principle of the selection of the laser sources 104 and 116 is that when it's possible to generate the same wavelengths as the central wavelengths λ₁ or λ₂, selecting the output of the any combination of the plurality of resonant wavelengths of the spectrums thereof by the switching of the driving current. In addition, the optical power of the output wavelengths λ₁ to λ₄ are, e.g. −8.2 dBm ` −7.9 dBm ` −8.9 dBm, and −8.1 dBm respectively, and the variation of the power of the output wavelengths λ₁ to λ₄ are, for example, less than 1 dB.

Since the optical-fiber gratings 110 reflects the passing optical signals back to the laser source 104, and cause enhancement and suppression on the original spectrum, the part of the spectrum having the same wavelengths as the central wavelengths λ₁ or λ₂ is enhanced, contrarily the other part having different wavelengths from the central wavelengths λ₁ or λ₂ is not enhanced, or even is suppressed. Moreover, since the spectrum of a laser source generally is not identical to more than two central wavelengths, as to the optical-fiber signal generating unit 100, only the signals having the same wavelength as the central wavelengths λ₁ or λ₂ is enhanced and outputted. In other words, as to an optical-fiber signal generating unit, the number of optical-fiber gratings corresponds to the number of switchable wavelengths.

The structure in FIG. 1 is an embodiment of the present invention designed with two units 100 and 112. Desired signals are outputted from the output terminal of each unit through the coupling of another optical coupler 114. Since each unit can provide two options of wavelength signals, thus through the on/off of the driving current Idc1 and Idc2, each has two switching values, 4 different wavelength signals can be obtained. According to the spectrums in FIGS. 2A, 2B, 3A, and 3B, e.g. when Idc1=18 mA and Idc2=0 mA, wavelength λ₁ (1539.78 nm) can be obtained. When Idc1=24 mA and Idc2=0 mA, wavelength λ₂ (1540.92 nm) can be obtained. When Idc1=0 mA and Idc2=16 mA, wavelength λ₃ (1542.04 nm) can be obtained. When Idc1=0 mA and Idc2=25 mA, wavelength λ₄ (1543.16 nm) can be obtained.

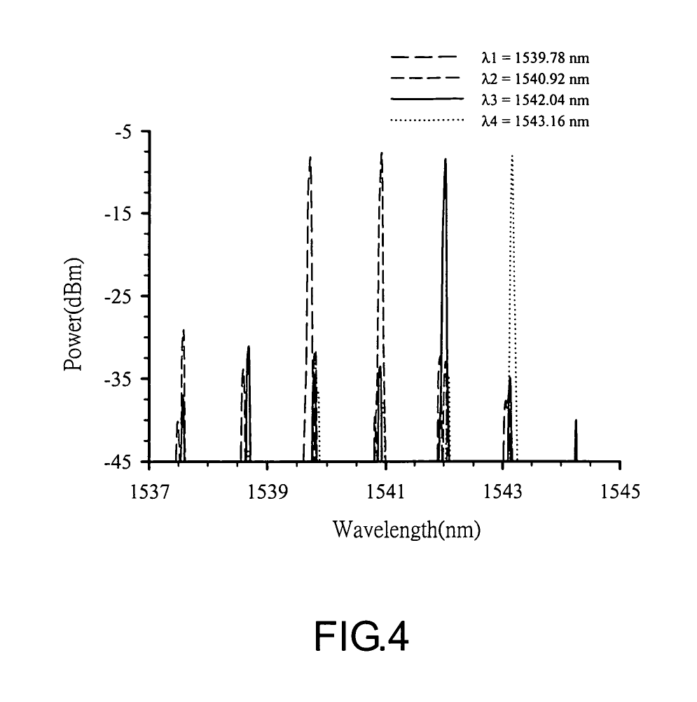

FIG. 4 illustrates the spectrums outputted in the embodiment in FIG. 1. Referring to FIG. 4, the side-mode suppression ratio (SMSR) is greater than 23 dB and has a frequency modulation range of 3.38 nm. That means it can be from −30 dBm to −7 dBm corresponding to the spectrums of λ₁ to λ₄. However, as described above, the present invention is not limited to the configuration in FIG. 1. The number of the optical-fiber signal generating units or the number of the optical-fiber gratings 110 can both be changed based on the same rule and corresponding to the laser source.

Before further describing the various designs of the present invention, the present invention is also allowed to do some adjustment in operation temperature. It can be seen from the spectrum, resonant wavelengths have certain spacing. For example, assuming that the selected wavelengths λ₁ and λ₂ and the used optical-fiber gratings are accidentally designed to be matching and corresponding to each other. Assuming the modulation gap Δν (or mΔν, m is an integer) of a Fabry-Perot laser diode is equal to |λ₁−λ₂| coincidentally, if two identical modes are infused into the Fabry-Perot laser diode, the SMSR value will be decreased or other unwanted modes are triggered. If Δν (or mΔν)=|λ1−λ2|, here in the present invention, the problem can be avoided by adjusting the modulation gap Δν of the diode through the control of the operation temperature. The center drift of the Fabry-Perot laser diode used in the present embodiment is about ±0.11 nm at ±10° C. Therefore, desired wavelength output can be obtained by controlling the temperature of the diode appropriately.

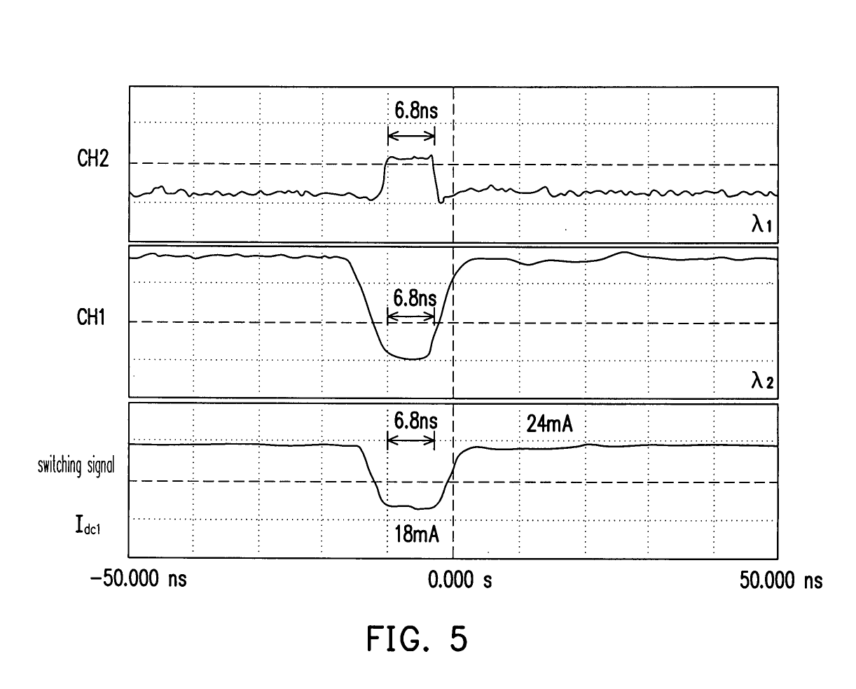

The wavelength switching technology of the present invention has been described above. Below, the switching response speed will be further explained below. Generally, an output gain can be generated only when the quantity of photons infused into the Fabry-Perot laser diode from external reaches a certain level. Thus, smaller photon infusing quantity will result in the decrease of SMSR. However, too much photons being infused is not always improving the SMSR due to the gain saturation in the laser diode. According to the structure in FIG. 1, the present invention also verifies the wavelength switching response time. Here the switching response time of the output wavelengths λ₁ and λ₂ is verified first. The laser source 104 is modulated under an anti-pulse signal source, the base current thereof (e.g. 18 mA and 24 mA) are used as high or low energy level switching, as shown in FIG. 5. The present invention uses, for example, a pulse signal as the switching signal, the bandwidth thereof is about 6.8 ns, and the increasing and decreasing times thereof are about 5 ns. As shown in FIG. 5, the valid wavelength switching response time (from λ₁ to λ₂) may reach 6.8 ns. Under the same measurement, the wavelength switching response time (from λ₃ to λ₄) may also reach 6.8 ns. Thereby, when external photons are infused, the gain competition in the Fabry-Perot laser diode is in an appropriate status and will result in the output of a single frequency optical wave. The wavelength switching response time can reach the level lower than 6.8 ns. The verification described above is only used for confirming that the response time of the present invention is in an acceptable range, and the actual verification quantities are only for reference, not for limiting the characteristics of the present invention.

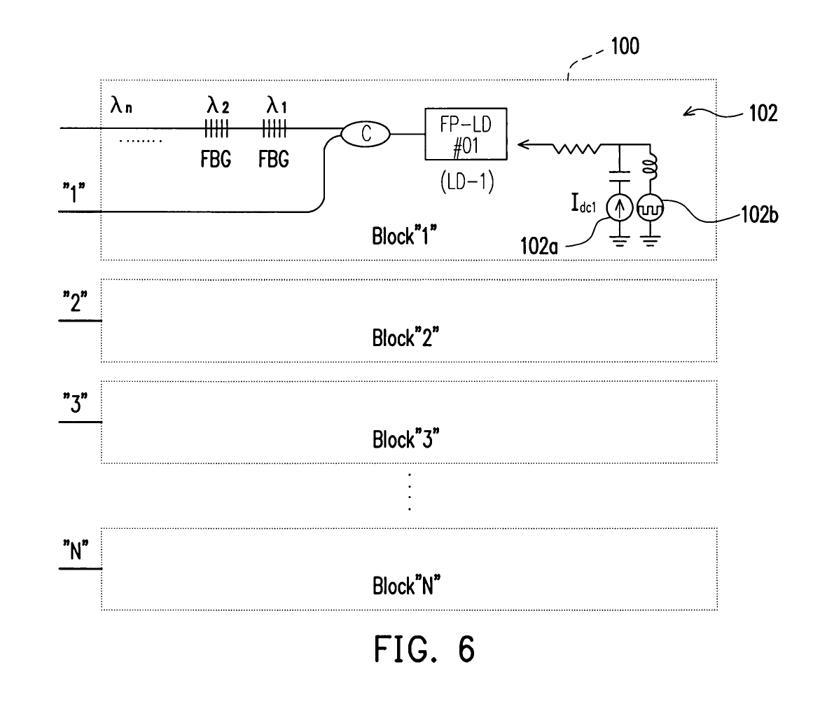

Because of the application of, for example, optical-fiber network, an array structure may be needed, as shown in FIG. 6. Assuming that each block has n adjustable wavelengths (n≦−1), when there are N blocks arranged into an array, there will be n×N wavelength outputs and N wavelengths are allowed to be outputted together. In such operation, a laser source module of multiple wavelength outputs can be obtained by using the design of the present invention described above. Wherein, each block can be like the unit 100 shown in FIG. 1, but each one has an individual output. In addition, the outputs of particular blocks can be coupled together using an optical coupler. In other words, based on the structure of a unit 100, it can be used by itself or can be combined with other units. The setting of the optical-fiber gratings of each block can be the same or different according to the actual requirement of the embodiment.

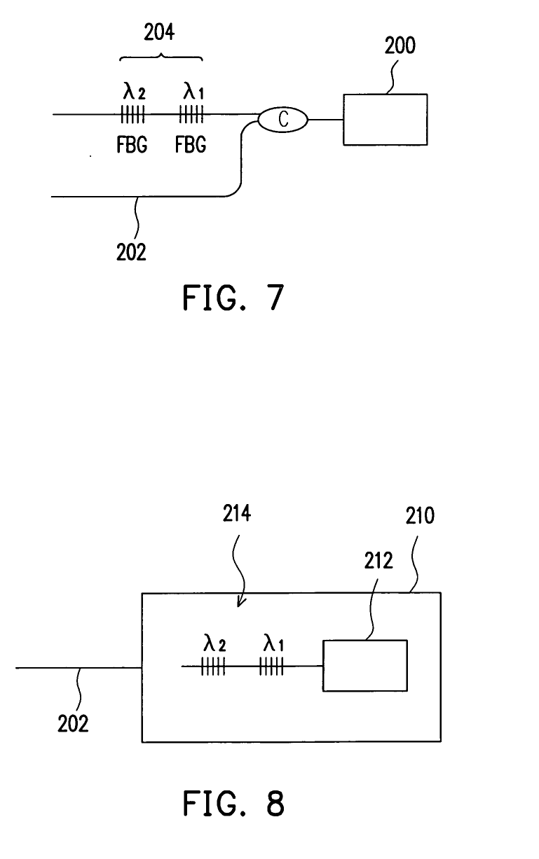

Furthermore, as to the fabricating of the present invention, semiconductor fabricating process can be used to integrate the laser source and the optical-fiber grating into a single semiconductor structure. FIG. 7 illustrates a semiconductor structure of the present invention, wherein the laser diode and driving circuit are fabricated into an IC unit 200 through semiconductor fabricating process. The optical-fiber grating 204 and the network optical-fiber 202 are both disposed externally. However, as to the semiconductor fabricating technology, the optical-fiber grating 204 may also be fabricated through semiconductor technology. FIG. 8 illustrates the semiconductor structure of the present invention. In FIG. 8, the optical-fiber signal generating unit 210, also referred as the laser semiconductor device too, for example, has integrated with the laser source structure and the driving circuit into a semiconductor circuit block 212. And the optical-fiber grating unit 214 and the circuit block 212 can be integrated into a single semiconductor structure, that is, laser semiconductor device 210 by using the semiconductor fabricating technology. As to the users, it can be connected to the network optical-fiber 212 to output the optical signal of desired wavelength through switching.

And it is remarkable that some particular embodiments described above can be combined appropriately without departing from the spirit and scope of the present invention.

In overview, low cost laser diode, e.g. Fabry-Perot laser diode, can be used in the present invention along with optical-fiber gratings having corresponding central wavelengths, thus the present invention has the advantages of simple structure, low price, data direct modulation, simple integration technology, adjustable wavelength, and the optical switching time lower than sub-nanosecond etc. The present invention can be applied to the Wavelength Divisional Multiplexed (WDM) system efficiently. And as to the future development of the passive optical network (WDM-PON), the present invention can also provide a low cost light source of multiple wavelengths to the optical line termination (OLT) or optical network unit (ONU) module.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An optical-fiber signal generator, comprising:
a driving unit, having an adjustable output current;
a laser source, driven by the output current of the driving unit, wherein a spectrum of the laser source includes at least one resonant wavelength;
an optical coupler, having a plurality of coupling terminals, wherein one of the coupling terminals is coupled to the laser source, another one of the coupling terminals serves as an output terminal for outputting an optical signal;
an optical-fiber, coupled to the optical coupler; and
at least one optical-fiber grating, disposed on the optical-fiber, wherein each optical-fiber grating has a central wavelength,
wherein by adjusting the output current of the driving unit, one of the at least one resonant wavelength of the laser source is matched to the central wavelength of one of the at least one fiber grating to produce the optical signal.

2. The optical-fiber signal generator as claimed in claim 1, wherein the at least one optical-fiber grating is a plurality of optical-fiber gratings, and the at least one resonant wavelength of the laser source is a plurality of resonant wavelengths.

3. The optical-fiber signal generator as claimed in claim 1, wherein the optical-fiber grating is Fiber Bragg Grating (FBG).

4. The optical-fiber signal generator as claimed in claim 1, wherein the driving unit includes:
a current source; and
a signal adjusting unit, coupled to the current source, wherein the output current is adjusted by the signal adjusting unit to drive the laser source.

5. The optical-fiber signal generator as claimed in claim 1, wherein the laser source includes Fabry-Perot laser diode.

6. An array structure for generating optical-fiber signals, comprising:
a plurality of wavelength signal generating units, wherein each of the wavelength signal generating units includes:
a driving unit, having an adjustable output current;
a laser source, driven by the output current of the driving unit, wherein a spectrum of the laser source includes at least one resonant wavelength;
an optical coupler, having a plurality of coupling terminals, wherein one of the coupling terminals is coupled to the laser source and another one of the coupling terminals serves as an output terminal for outputting an optical signal;
an optical-fiber coupled to the optical coupler; and
at least one optical-fiber grating disposed on the optical-fiber, wherein each optical-fiber grating has a central wavelength,
wherein by adjusting the output current of the driving unit, one of the resonant wavelengths of the laser source is matched to the central wavelength of one of the fiber gratings to produce the optical signal.

7. The array structure as claimed in claim 6, wherein after a desired wavelength has been obtained through adjusting of the laser source of each of the wavelength signal generating units, the wavelength signal generating units generate the optical signals at the same time to form and output an optical array signal.

8. The array structure as claimed in claim 7, wherein the laser sources of the wavelength signal generating units have the same spectrum characteristics.

9. The array structure as claimed in claim 7, wherein the laser sources of the wavelength signal generating units include at least two different spectrum characteristics.

10. The array structure as claimed in claim 7, wherein the central wavelengths of the optical-fiber gratings in the wavelength signal generating units are the same, or at least two being different.

11. The array structure as claimed in claim 6, further including an optical coupler which is a 1×N (N>1) optical coupler coupled to a portion of or all of the output terminals of the wavelength signal generating units to obtain an optical signal with the desired wavelength.

12. The array structure as claimed in claim 11, wherein the optical signal with desired wavelength is generated by switching to one of the wavelength signal generating units.

13. The array structure as claimed in claim 11, wherein the laser sources of the wavelength signal generating units have the same spectrum characteristics.

14. The array structure as claimed in claim 11, wherein the laser sources of the wavelength signal generating units include at least two different spectrum characteristics.

15. The array structure as claimed in claim 11, wherein the central wavelengths of the optical-fiber gratings in the wavelength signal generating units are the same, or at least two being different.

16. The array structure as claimed in claim 6, wherein in each of the wavelength signal generating units, the at least one optical-fiber grating is a plurality of optical-fiber gratings, and the at least one resonant wavelength of the laser source is a plurality of resonant wavelengths.

17. The array structure as claimed in claim 6, wherein in each of the wavelength signal generating units, the optical-fiber grating is Fiber Bragg Grating (FBG).

18. The array structure as claimed in claim 6, wherein in each of the wavelength signal generating units, the driving unit includes:
a current source; and
a signal adjusting unit, coupled to the current source, wherein the output current is adjusted by the signal adjusting unit to drive the laser source.

19. The array structure as claimed in claim 6, wherein in each of the wavelength signal generating units, the laser source includes Fabry-Perot laser diode.

20. A laser semiconductor device, comprising:
a driving circuit structure used, for generating an adjustable output current;
a laser source structure, driven by the output current of the driving circuit, wherein a spectrum of the laser source includes at least a resonant wavelength;
a terminal structure; and
an optical-fiber grating structure, coupled to the laser optical structure through the terminal structure, wherein the optical-fiber grating structure includes at least one optical-fiber grating, each optical-fiber grating has a central wavelength;
wherein by adjusting the output current of the driving unit, one of the resonant wavelengths of the laser source is matched to the central wavelength of one of the fiber gratings to produce an optical signal, which is outputted by the terminal structure.
